(19) United States
(12) Patent Application Publication
(10) Pub. No.: US 2025/0358849 A1
(43) Pub. Date: Nov. 20, 2025

(54) ENABLING COMPLIANCE TO TRANSMIT OPPORTUNITY LIMIT FOR MULTI-ACCESS POINT COORDINATED TDMA

(71) Applicant: Cisco Technology, Inc., San Jose, CA (US)

(72) Inventors: Brian D. Hart, Sunnyvale, CA (US); Binita Gupta, San Diego, CA (US); Malcolm M. Smith, Richardson, TX (US)

(21) Appl. No.: 19/190,034

(22) Filed: Apr. 25, 2025

Related U.S. Application Data
(60) Provisional application No. 63/647,330, filed on May 14, 2024.

(51) Int. Cl. H04W 74/0816; H04W 72/0446; H04W 74/00

(52) U.S. Cl. CPC H04W 74/0816; H04W 72/0446; H04W 74/002

(57) ABSTRACT

A method is performed by an access point (AP) using coordinated time division multiple access (Co-TDMA) with multi-AP coordination (MAPC). The method comprises: upon acquiring a transmit opportunity (TXOP) having a TXOP duration for traffic of an access category among prioritized access categories, exchanging the traffic with a client during a portion of the TXOP; and transmitting, to a first AP, a first outbound control frame configured to allocate, to the first AP, a first shared portion of the TXOP duration to be used by the first AP to exchange first traffic for the access category or a higher priority access category with a first client, wherein the first outbound control frame includes a multi-user request-to-send TXOP sharing trigger frame having a first indication of the first shared portion of the TXOP duration, and a second indication of the access category.

### CROSS REFERENCE TO RELATED APPLICATION

This application claims priority to U.S. Provisional Patent Application No. 63/647,330, filed May 14, 2024, incorporated herein by reference in its entirety.

### TECHNICAL FIELD

The present disclosure relates to wireless local area network operations.

### BACKGROUND

A first access point (AP), using Coordinated Time Division Multiple Access (Co-TDMA), may acquire a transmit opportunity (TXOP). When the first AP does not use the full TXOP, or when the first AP becomes aware of a second AP that has higher priority traffic to transmit, the first AP may grant a portion or a remainder of the TXOP to a second AP. The first and/or second APs may repeat the aforementioned operations to grant a further portion or remainder of the TXOP to at third AP, and so on. Conventional techniques applied to such TXOP sharing may not carefully adhere to or enforce a maximum TXOP limit for the TXOP and can therefore be unfair to legacy APs and their clients or stations (STAs).

In Co-TDMA, a network allocation vector (NAV) may be extended via TXOP chaining. For example, the first AP extends the NAV by a short interframe space (SIFS) or point coordination function (PCF) interframe space (PIFS) to block access by other APs/STAs but explicitly invites the second AP to participate in the TXOP if free; however, this does not prevent the above-mentioned unfairness to the legacy APs and their clients (e.g., it may create an unboundedly long TXOP and thereby result in a poor level of unfairness).

### BRIEF DESCRIPTION OF THE DRAWINGS

FIG. 1 is a multi-AP (MAP) coordination (MAPC) system in which transmit opportunity (TXOP) sharing control by APs using Coordinated Time Division Multiple Access (Co-TDMA) with MAP coordination (MAPC) (Co-TDMA/MAPC) may be implemented, according to an example embodiment.

FIG. 2 is a timing diagram of single AP TXOP sharing control, according to an example embodiment.

FIG. 3 is a timing diagram of distributed AP TXOP sharing control, according to an example embodiment.

FIG. 4 is an illustration of control frame fields for a control frame that shares/allocates a portion/remainder of a TXOP duration of a TXOP obtained for an access category, according to an example embodiment.

FIG. 5 is an illustration of fields that may be carried in a TXOP return frame, according to an example embodiment.

FIG. 6 is a flowchart of a method of single AP TXOP sharing control performed by an AP using Co-TDMA/MAPC.

FIG. 7 is a flowchart of a method of distributed AP TXOP sharing control performed by an AP using Co-TDMA/MAPC.

FIG. 8 illustrates a hardware block diagram of a computing device that may perform functions associated with operations discussed herein, according to an example embodiment.

### DESCRIPTION OF EXAMPLE EMBODIMENTS

### Overview

In one embodiment, a method is provided that is performed by an access point (AP) using coordinated time division multiple access (Co-TDMA) with multi-AP coordination (MAPC), wherein the method includes: upon acquiring a transmit opportunity (TXOP) having a TXOP duration for traffic of an access category among prioritized access categories, exchanging the traffic with a client during a portion of the TXOP; and transmitting, to a first AP, a first outbound control frame configured to allocate, to the first AP, a first shared portion of the TXOP duration to be used by the first AP to exchange first traffic for the access category or a higher priority access category with a first client, wherein the first outbound control frame includes a multi-user request-to-send TXOP sharing trigger frame having a first indication of the first shared portion of the TXOP duration, and a second indication of the access category.

In another embodiment, a method is provided that is performed by an AP using Co-TDMA with MAPC, wherein the method includes: receiving an inbound control frame transmitted by a first AP that acquired a transmit opportunity (TXOP) with a TXOP duration, wherein the inbound control frame is configured to transfer control of the TXOP from the first AP to the AP, and the inbound control frame indicates a first remainder of the TXOP duration that is unused and available for sharing; self-allocating a portion of the first remainder for exchanging AP traffic with a client; and decrementing the first remainder by the portion to produce a second remainder that is unused and available for sharing with a second AP or being returned to the first AP for subsequent sharing.

### Example Embodiments

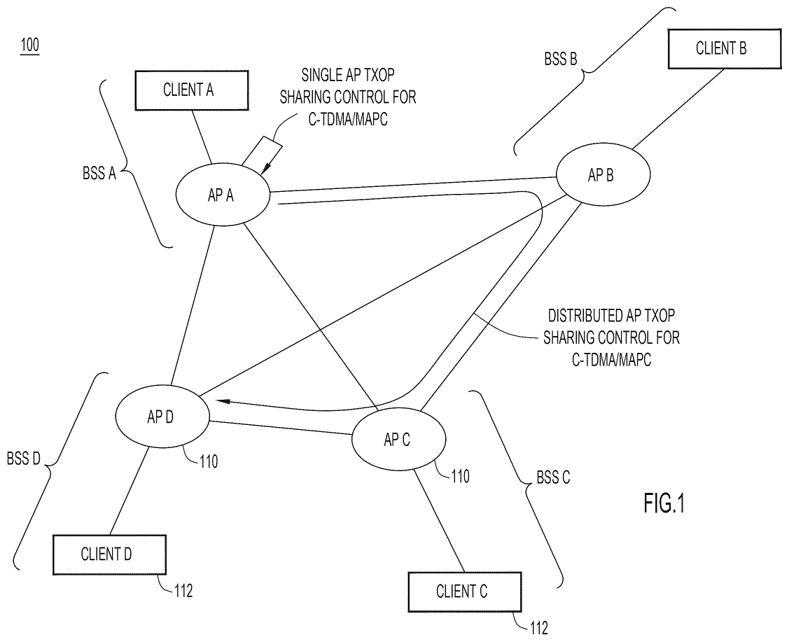

FIG. 1 is an example multi-access point (AP) (MAP) system 100 in which embodiments for TXOP sharing control by APs using Coordinated Time Division Multiple Access (Co-TDMA) with MAP coordination (MAPC) (Co-TDMA/MAPC) may be implemented. MAP system 100 includes multiple wireless APs (individual referred to as an “AP” and collectively referred to as “APs”) associated with respective wireless client devices (also referred to simply as “clients,” “stations (STAs),” or “non-AP STAs”). For example, a client A is associated with an AP A on a Basic Service Set (BSS) A, a client B is associated with an AP B on a BSS B, a client C is associated with an AP C on a BSS C, and a client D is associated with an AP D on a BSS D. In the example, one client is associated with each AP's BSS. More typically, however, multiple clients may be associated with each AP's BSS, that is, one or more clients may be associated with each AP's BSS. APs A-D are collectively referred to as APs 110, and clients A-D are collectively referred to as clients 112. Each AP may communicate with a network (not shown) that includes one or more local area networks, and one or more wide area networks (WANs), such as the Internet.

APs 110 and clients 112 are configured to communicate with each other using one or more communication protocols, such as IEEE 802.11 Co-TDMA with MAPC protocols, for example. In IEEE 802.11, Enhanced Distributed Channel Access (EDCA) defines prioritized access categories (ACs) for traffic to enable Quality of Service (Qos). In order from highest to lowest priority, the ACs include voice (AC_VO), video (AC_VI), best effort (AC_BE), and background (AC_BK).

According to embodiments presented herein, when an AP has buffered traffic (referred to simply as “traffic”) for a particular access category (AC) (e.g., for AC_VI), the AP contends for and acquires a TXOP that has a TXOP duration during which the AP can exchange the traffic with a client. The TXOP duration does not exceed a maximum TXOP limit (also referred to simply as a “TXOP limit”) according to the particular AC, as described further below. The AP (referred to as the “acquiring” AP) can share any remaining TXOP duration with other APs. The AP may implement a TXOP control policy such that when the BSS of the AP does not have traffic for the particular AC or a higher priority AC, the AP cannot contend for the TXOP, or if there is high priority traffic, then the AP cannot elongate the TXOP to include other traffic; and if during the TXOP the AP delivers all of its high priority traffic, then the AP cannot itself use the remainder of the TXOP for lower priority traffic. Moreover, as soon as the AP makes this determination (i.e., that it cannot use the remainder of the TXOP), the AP should terminate the TXOP or grant the remaining time of the TXOP duration to another AP on a BSS that might have such traffic.

The TXOP duration is equal to a TXOP limit determined/defined according to (i.e., set by) the particular AC for which the TXOP was obtained, or may be a lower limit when the acquiring AP has little traffic to send. The different ACs may set different TXOP limits. For example, ACs AC_VO, AC_VI, and AC_BE may set first, second, and third TXOP limits for the TXOP duration that differ from each other. As an alternative, a single Co-TDMA/MAPC TXOP limit may be established for multiple ACs (which may include all of the ACs or a subset of the ACs). This might arise from calculating the TXOP limit for Co-TDMA with AC_xx as min(TXOPlimit(AC_xx), TXOPlimit(AC_VI)), such that any AC_xx with a TXOP limit larger than AC_VI ends up with the same TXOP limit as AC_VI, and thereby they form a set of ACs with a common TXOP limit for Co-TDMA. Each AP may store predetermined information that maps the ACs to their corresponding TXOP limits. According to embodiments presented herein, APs 110 share the TXOP obtained by the acquiring AP in a way that ensures fairness to legacy APs and clients, and adherence to the TXOP limit for the TXOP.

In a first embodiment, the acquiring AP alone controls TXOP sharing of successive portions of the TXOP duration with successive ones of the APs. While sharing the TXOP duration, the acquiring AP serves as a single point of control for the TXOP sharing to enforce adherence to the TXOP limit. The first embodiment is also referred as “single AP TXOP sharing control.” In contrast, a second embodiment distributes control of the TXOP to successive APs, starting with the acquiring AP. The acquiring AP initially controls sharing the TXOP, then passes the TXOP sharing control to a second AP, which then passes the TXOP sharing control to a third AP, and so on. The APs collectively enforce adherence to the TXOP limit. The second embodiment is also referred to as “distributed AP TXOP sharing control.”

The first embodiment, (i.e., the single AP TXOP sharing control) is now described, using AP A as the single point of control. At a high level, AP A initially acquires a TXOP with a TXOP duration that has a TXOP limit, and then manages or controls sharing of successive portions of the TXOP duration with successive neighbor APs, while ensuring that the TXOP sharing does not exceed the TXOP duration (and TXOP limit) acquired. After using a shared portion of the TXOP duration, each neighbor AP returns control of the TXOP to AP A, for a next round of sharing by AP A.

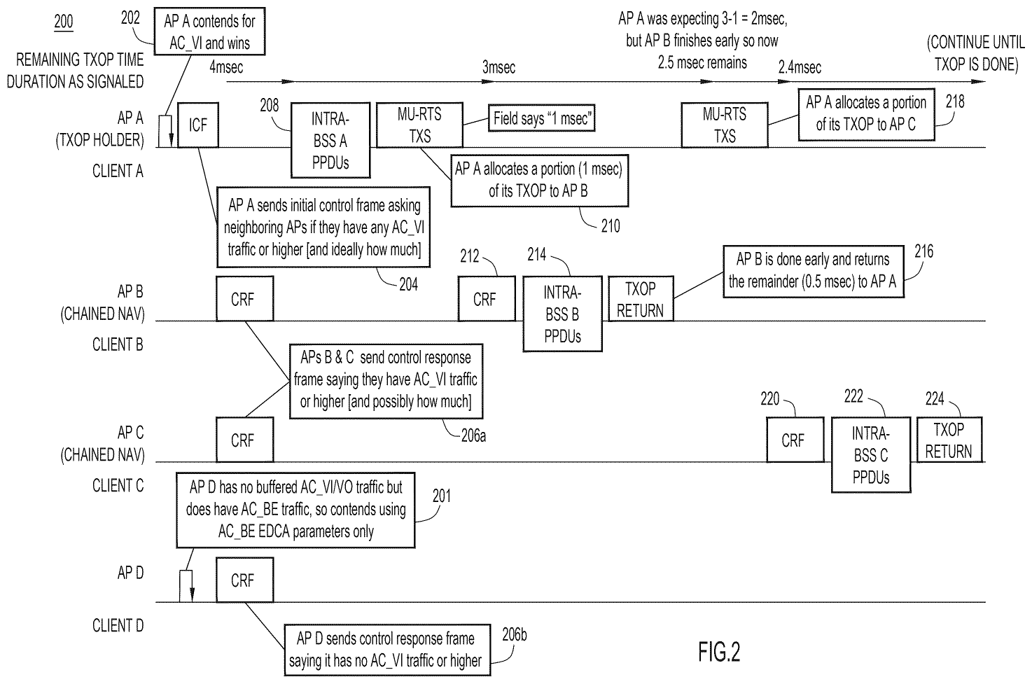

As described further below in connection with FIG. 2, AP A shares the TXOP with AP B (this transaction is denoted “A2B”), which then returns control of the TXOP back to AP A (this transaction is denoted “B2A”). Next, AP A shares the TXOP with AP C (denoted “A2C”), which then returns control of the TXOP back to AP A (denoted “C2A”). The aforementioned single AP TXOP sharing control sequence is denoted “A2B2A2C2A.”

While sharing the successive portions of the TXOP duration, AP A maintains a running or current total of how much of the (initially acquired) TXOP duration remains unused (i.e., has not been shared) at any given time and is thus available for further sharing. The running total is referred to as a “remainder” and equals the TXOP limit(the TXOP duration that is initially acquired) minus the “elapsed time” of the TXOP duration. AP A may maintain the remainder as an internal state variable. To ensure that the TXOP sharing (i.e., successive allocations of shared portions) does not exceed the TXOP limit, AP A only shares a portion of the TXOP when the remainder is greater than zero. Initially, AP A sets the remainder equal to the TXOP duration, and then decrements the remainder each time AP A allocates a portion (referred to as a “shared portion” or an “allocated portion”) of the TXOP duration. Conversely, when a neighbor AP returns back to AP A an unused portion of its shared/allocated portion, AP A increments the remainder by the unused portion.

As used herein, the term “portion” of a TXOP duration (or TXOP) may also be referred to as any of a “time slice,” an “allocation,” and a “time allocation” Also, the term “allocating” a portion of the TXOP duration may be referred to as any of “sharing” and “granting” the portion of the TXOP duration.

FIG. 2 is a timing diagram of example single AP TXOP sharing control 200. FIG. 2 shows the above-described single AP TXOP sharing control sequence “A2B2A2C2A.”

At 201, AP D has low priority traffic (e.g., AC_BE traffic) for client D, but does not have high priority QoS traffic (e.g., AC_VI traffic or AC_VO traffic). Therefore, AP D contends for a TXOP using AC_BE EDCA parameters only.

At 202, AP A has traffic for a particular AC. AP A contends for and wins a TXOP for the particular AC. Given the AC, the TXOP duration has a maximum value equal to the TXOP limit for the AC (e.g., 4 msec). In the example, AP A acquires a TXOP for AC_VI traffic, and the TXOP duration is equal to a TXOP limit for AC_VI. AP A initially sets the remainder (i.e., the unused portion) of the TXOP duration equal to the TXOP duration (i.e., equal to the TXOP limit). AP A is the acquiring AP and may also be referred to as the “TXOP holder.”

After acquiring the TXOP, at 204, AP A sends an initial control frame (ICF) to neighbor APs B, C, and D. The initial control frame requests from neighbor APs B, C, and D indications of their buffered traffic, including at the AP (downlink) and/or understood to be at the clients associated to the AP (uplink). Of particular interest is whether they have any traffic for the particular AC or for a higher priority AC (e.g., traffic for AC_VI or for higher) and how much, as measured by medium time or similar.

In response to the initial control frame ICF, at 206a, APs B and C send to AP A respective control response frames (CRFs) (also referred to as “initial control response (ICR) frames,” because they respond to the ICF) that indicate APs B and C have traffic for the particular AC or a higher priority AC (e.g., traffic for AC_VI or higher). Each CRF may also indicate an amount of traffic in total, or in total for the AC or higher, or per AC for some or all ACs (e.g., described in terms of a medium time to transfer the traffic). Similarly, in response to the initial control frame, at 206b, AP D sends to AP A an CRF that indicates AP D has no buffered traffic for the particular AC or a higher priority AC (e.g., no traffic for AC_VI or higher), such as a binary indication, or a total for the AC or a higher AC, or a total per AC for some or all ACs, or similar.

Operations 204-206b described above are collectively referred to as “polling the neighbor APs for their traffic information.” AP A records in memory AP traffic information returned by the neighbor APs via the respective CRFs. In another example, AP A may estimate the AP traffic information based on previous out-of-band messages between the APs about the periodic flows each AP is servicing, using known techniques. The aforementioned “polling” and “estimating” techniques may be referred to broadly as “determining the AP traffic information.” The AP traffic information may include a list of AP identifiers (IDs) of APs that have traffic for AC=AC_VI or higher, and may also indicate aspects of the traffic for each AP that is identified, such as medium time per AC.

AP A determines with which APs to share the TXOP based on the APs, and their ACs, identified in the AP traffic information. That is, AP A shares the TXOP with some or all of those APs identified in the AP traffic information that have traffic for the particular AC or a higher priority AC. AP A may give selection priority to APs with buffered traffic in the highest AC. In another embodiment, periodic flow requirements, as soon as they are learnt, are sent ahead of time between nearby APs. AP A, without dynamically polling other APs, therefore, has a good sense of which APs are likely to have QoS traffic buffered, and allocates time to them without detailed responses in 206a/b.

At 208, AP A allocates to itself (i.e., self-allocates) a portion (e.g., 1 msec) of the maximum or otherwise determined (e.g., lower than the TXOP limit and as a function of the self-allocated medium time) TXOP duration (e.g., 4 msec). The self-allocated portion is less than the TXOP duration. During the self-allocated portion, AP A exchanges with client A intra-BSS A PPDUs that carry traffic for the particular AC or higher (and may also carry traffic of a lower priority AC if the portion is not elongated). For example, AP A transmits (e.g., a processor of AP A causes AP A to transmit) to client A down-link (DL) PPDUs, and receives from the client uplink (UL) PPDUs, that carry the traffic. AP A decrements the TXOP duration (e.g., 4 msec) by the self-allocated portion (e.g., 1 msec), leaving a first remainder or unused portion (e.g., 4−1=3 msec) of the TXOP duration available for allocation to (i.e., sharing with) one or more neighbor APs. In the example, AP A determines that the first remainder is greater than zero. Therefore, AP A can share the TXOP.

After the PPDU exchange, at 210, AP A determines that AP B has traffic for the particular AC or a higher AC based on the AP traffic information, and determines that the first remainder is greater than zero. Responsive to the determinations, AP A shares the TXOP with AP B in the following manner. AP A sends to AP B a control frame (e.g., a first outbound control frame with respect to AP A) that allocates to AP B a first shared portion (e.g., 1 msec) of the TXOP duration taken from the first remainder (or in one example, the whole first remainder) for use by AP B for exchanging traffic of the particular AC or a higher priority AC with client B. In an example, the control frame may be similar to a multi-user (MU) request-to-send (RTS) TXOP sharing (TXS) (MU-RTS-TXS) trigger frame, modified or extended to incorporate information in accordance with the embodiments presented herein. The control frame includes a first field to indicate the first shared portion (e.g., 1 msec, leaving 3−1=2 msec of the first remainder unshared), and may include a second field that indicates the particular AC (e.g., AC=AC_VI) for which the TXOP was initially acquired by AP A. At this time, AP A may decrement the first remainder (e.g., 3 msec) by the first shared portion (e.g., 1 msec), to produce a second remainder. Alternatively, AP A may wait to decrement the first remainder when AP has additional information, as described below.

Upon receiving the control frame, at 212, AP B sends to AP A a CRF acknowledging receipt of the control frame. At 214, during the first shared portion allocated to AP B, AP B exchanges intra-BSS B PPDUs carrying traffic for the particular AC or higher with client B. AP B may or may not use all of the first shared portion. Following the intra-BSS B PPDU exchange, at 216, AP B sends to AP A a TXOP return frame that returns to AP A an unused portion (also referred to as a “returned portion”) of the first shared portion/TXOP duration that AP B did not use (if available) and enables AP A to continue the TXOP. The TXOP return frame may include a control frame, a data frame, or a management frame, for example. In the example, AP B returns to AP A 0.5 msec of the first shared portion (i.e., the returned portion=0.5 msec).

The TXOP return frame includes a field that carries an indication of the returned portion (also referred to as a “TXOP portion return indication”), which may be 0 when AP B uses the entire first shared portion, or greater than zero when AP B does not use the entire first shared portion. The indication may define the returned portion in different ways, such as how much of the first shared portion was actually used by AP B (referred to as a “used portion” of the first shared portion), how much of the first shared portion was not used by AP B (referred to as an “unused portion” of the first shared portion), and so on. Alternatively, this field may not be transmitted explicitly and instead AP A may determine the value of the field based on the timing of the grant and TXOP return frames.

Upon receiving the TXOP return frame (which is an inbound control frame with respect to AP A), AP A computes a second remainder (which represents the current unused portion) of the TXOP duration that is available to AP A for further sharing with another AP, based on the first remainder and the returned portion. In a first example in which the TXOP return field defines the returned portion as the used portion, AP A decrements the first remainder by the used portion, to produce the second remainder (e.g., the second remainder=3−0.5=2.5 msec). In a second example in which the TXOP return field defines the returned portion as the unused portion, AP A decrements the first remainder by a difference between the first shared portion and the unused portion, to produce the second remainder (e.g., the second remainder=3−(1−0.5)=2.5 msec. In another example, upon receiving the inbound control frame, the AP may make a direct measurement of the (actual) used portion and then compute the second remainder based on the direct measurement. In the example, the second remainder is greater than 0. Therefore, AP A can continue sharing the TXOP.

At 218, AP A determines that AP C has traffic for the particular AC or a higher AC based on the AP traffic information, and that the second remainder is greater than zero. Therefore, AP A shares the TXOP with AP C. AP A sends to AP C a control frame (e.g., a second outbound control frame) that allocates to AP C a second shared portion (e.g., 1 msec) of the TXOP duration taken from the second remainder for use by AP C for exchanging traffic of the particular AC or a higher priority AC with client C. The control frame includes a first field to indicate the second shared portion (e.g., 1 msec), and may include a second field that indicates the particular AC (e.g., AC=AC_VI) for which the TXOP was initially acquired by AP A. At this time, AP A may decrement the second remainder by the second shared portion, to produce a third remainder. Alternatively, AP A may wait until later to decrement the second remainder.

Upon receiving the control frame sent at 218, at 220, AP C sends to AP A a CRF acknowledging receipt of the control frame. At 222, during the second shared portion allocated to AP C, AP C exchanges intra-BSS C PPDUs carrying traffic for the particular AC or higher with client C. Following the intra-BSS C PPDU exchange, at 224, AP C sends to AP A a TXOP return frame that returns to AP A any unused portion (i.e., a returned portion) of the second shared portion that AP C did not use (if available) and enables AP A to continue the TXOP. AP A continues to share the TXOP as described above until the TXOP duration is used up, else AP A terminates the TXOP early such as by sending out a frame that terminates the NAV protection or by not continuing the TXOP after a shared AP returns the rest of the TXOP to AP A.

The second embodiment (i.e., the distributed AP TXOP sharing control) is now described. At a high-level, distributed AP TXOP sharing control distributes control of TXOP sharing (i.e., TXOP sharing control) across APs 110. That is, each AP passes control of sharing the TXOP (i.e., also referred to simply as “control of the TXOP”) to a successive or next AP. By way of example, the APs share successive portions of an initially acquired TXOP duration in the following sequence. AP A (the initial TXOP holder) initially acquires a TXOP with a TXOP duration, self-allocates a first portion of the TXOP duration, leaving a first remainder unused. AP A passes control of the TXOP along with the first remainder to AP B (“A2B”), which becomes the next TXOP holder. AP B self-allocates a second portion of the first remainder, leaving a second remainder. AP B passes control of the TXOP along with the second remainder to AP C (“B2C”), which becomes the next TXOP holder. The TXOP sharing control continues until the remainder decrements to zero (i.e., only while the remainder is greater than zero). Then the TXOP sharing stops. The aforementioned TXOP sharing sequence is denoted “A2B2C.” Variations include an earlier AP, such as A2B2C2A2D.

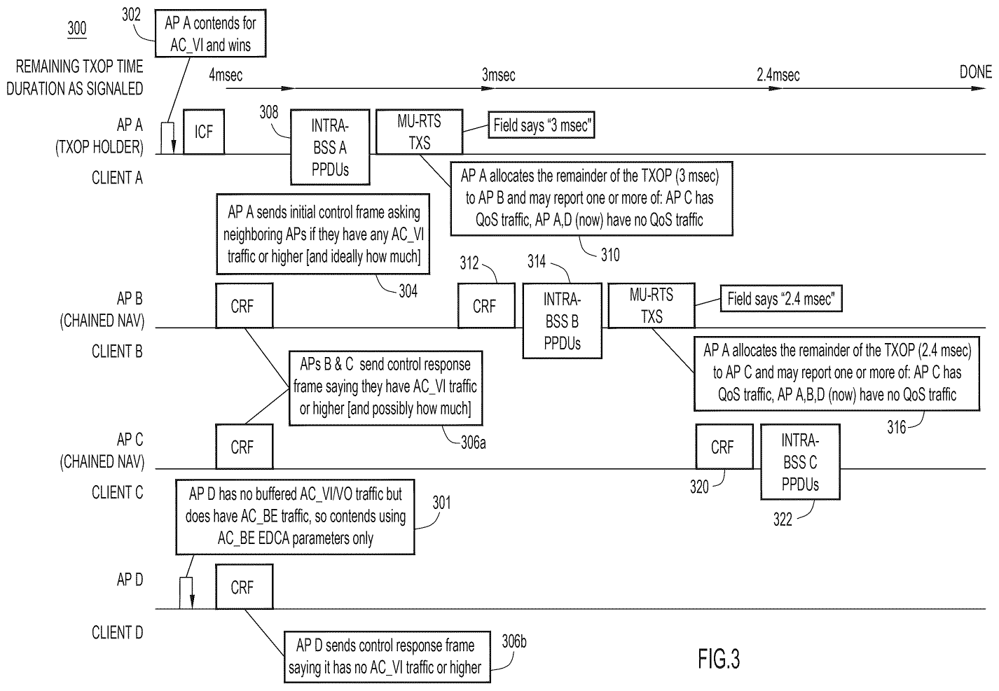

FIG. 3 is a timing diagram for an example of distributed AP TXOP sharing control 300. FIG. 3 shows the above-described distributed AP TXOP sharing control sequence “A2B2C.”

Operations 301, 302, 304, 306a, and 306b are similar to corresponding operations 201, 202, 204, 206a, and 206b described above in connection with FIG. 2; therefore the description of operations 201-206b shall suffice for operations 301-306b. Responsive to operations 301-306b, AP A (the acquiring AP) records AP traffic information for APs B and C, as described above.

At 308, AP A self-allocates a first portion (e.g., 1 msec) of the TXOP duration (e.g., 4 msec). The first portion is less than the TXOP duration. During the first portion, AP A exchanges with client A intra-BSS A PPDUs that carry traffic of the particular AC. AP A decrements the TXOP duration, by the first portion, leaving a first remainder or unused portion of the TXOP duration for allocation to a next AP. In the example, the first remainder is greater than zero (e.g., 4−1=3 msec). Therefore, AP A can share the TXOP, and pass control of the TXOP to the next AP.

After the PPDU exchange, at 310, AP A determines that AP B has traffic for the particular AC or a higher AC based on the information list, and that the first remainder is greater than zero. Therefore, AP A passes control of the TXOP to AP B, and shares the first remainder of the TXOP with AP B in the following manner. AP A sends to AP B a control frame (which may be similar to an MU-RTS TXS trigger frame, for example) that allocates to AP B the first remainder (e.g., 3 msec) (also referred to as a “first shared portion”) of the TXOP duration for use by AP B. The first remainder represents all of the unused TXOP duration at the current time. The control frame includes a first field to indicate the first remainder (e.g., 3 msec), an optional second field that indicates the particular AC (e.g., AC=AC_VI) for which the TXOP was initially acquired, and an optional third field that includes the AP traffic information (e.g., that identifies APs with traffic for the particular AC category or a higher category).

Upon receiving the control frame, at 312, AP B sends to AP A a CRF acknowledging receipt of the control frame. At 314, AP B self-allocates a portion of the first remainder (e.g., 0.6 msec) and uses the portion to exchange intra-BSS B PPDUs carrying traffic for the particular AC or higher with client B. AP B decrements the first remainder by the portion, leaving a second remainder (e.g., 3−0.6=2.4 msec). The second remainder is greater than zero, therefore AP B can pass control of the TXOP (and continue to share the TXOP) with a next AP.

At 316, AP B determines that AP C has traffic for the particular AC or a higher AC based on the AP traffic information, and that the second remainder is greater than zero. Therefore, AP B passes control of the TXOP to AP C, and shares the TXOP with AP C in the following manner. AP B sends to AP C a control frame (e.g., another MU-RTS TXS trigger frame) that allocates to AP C the second remainder (e.g., 2.4 msec) of the TXOP duration for use by AP C. The second remainder represents all of the unused TXOP duration. The control frame includes a first field to indicate the second remainder (e.g., 2.4 msec), an optional second field that indicates the particular AC (e.g., AC=AC_VI) for which the TXOP was initially acquired, and an optional third field that includes the AP traffic information (e.g., that identifies APs with traffic for the particular AC category or a higher category).

Upon receiving the control frame sent at 316, at 320, AP C sends to AP A a CRF acknowledging receipt of the control frame. At 322, AP C allocates to itself a portion of the second remainder and uses the portion to exchange intra-BSS C PPDUs carrying traffic for the particular AC or higher with client C. AP C decrements the second remainder by the portion, leaving a third remainder. The APs continues to pass the TXOP until the TXOP duration is used up.

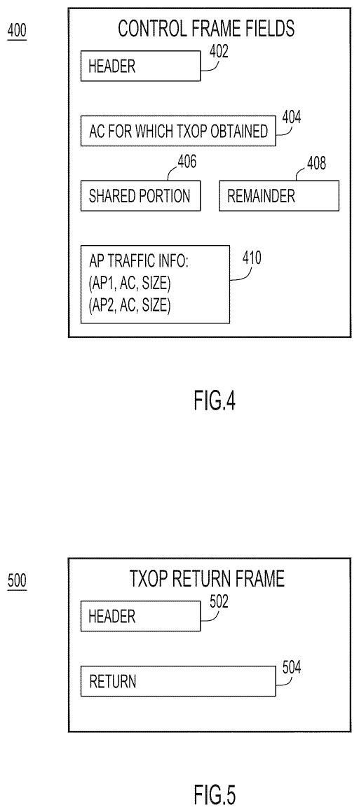

FIG. 4 is an illustration of example fields 400 that may be carried in a control frame that shares/allocates a portion/remainder of a TXOP duration of a TXOP obtained for an AC. The control frame may carry all of fields 400 or only a subset of the fields. Fields 400 include a header 402 that includes transmitter and receiver MAC addresses of sending and receiving APs and other header information. Fields 400 further include indications of: the AC 404 for which the TXOP was obtained (this field may be omitted or simplified in an embodiment that uses the single Co-TDMA/MAPC TXOP limit for multiple ACs); a shared portion 406 of the TXOP duration that is allocated to a receiving or grantee AP; and a remainder 408 of the TXOP duration that is allocated to the receiving or grantee AP for the receiving/grantee AP to further allocate to the next AP. In another embodiment, a single remaining TXOP duration is included, and the receiving/grantee AP selects the portion it uses for its own BSS or, equivalently, the portion it further allocates to the next AP. Fields 400 may also include AP traffic information 410 having entries that identify (i) APs AP1, AP2, and so on, holding traffic (e.g., where AP1=AP B and AP2=AP C in the example of FIG. 2 in which AP A sends the control frame), (ii) the ACs for the traffic, and (iii) sizes/amounts/medium time durations of the traffic.

The indication for AC 404 may include a 2-bit identifier, for example. AP traffic information 410 may include AP IDs represented as short AP IDs, BSS IDs (BSSIDs), media access control (MAC) addresses, or a bitmap whose bit positions were previously defined during AP-to-AP signaling, for example. By way of example, shared portion 406 and remainder 408 may each include a fixed-bitwidth field, e.g., up to 16 bits having units of one usec. As an alternative, for compactness, a lower TXOP duration (e.g., a TXOP limit) (e.g., in a range of 3-10 msec) and/or lower resolution (e.g., 1/8/16/64/256 usec) may be used. As described previously, the sum of the two fields might be transmitted instead of the two individual fields.

Referring also to FIG. 2, the control frames sent by AP A at 210 and 218 may each include all of fields 400, except remainder 408, for example. Referring also to FIG. 3, the control frames respectively sent by AP A and AP B at 310 and 316 may each include all of fields 400, except for shared portion 406, for example. In an alternative, an acquiring AP may send some of fields 400, including shared portion 406 and/or remainder 408, to a next AP in an initial control frame (e.g., in FIG. 2, the ICF sent at 204), with a caveat that the signaled time is an estimate/lower bound/upper bound, which may vary based on retries.

FIG. 5 is an illustration of example fields 500 that may be carried in a TXOP return frame, sent at 216 in FIG. 2, for example. All of fields 500 or only a subset of the fields may be carried in the TXOP return frame. Fields 500 include a header 502 and a return field 504. Return field 504 indicates an unused portion (i.e., a returned portion) of a previously allocated part of a TXOP duration, or indicates a used portion of that previously allocated part, as described above in connection with FIG. 2, for example.

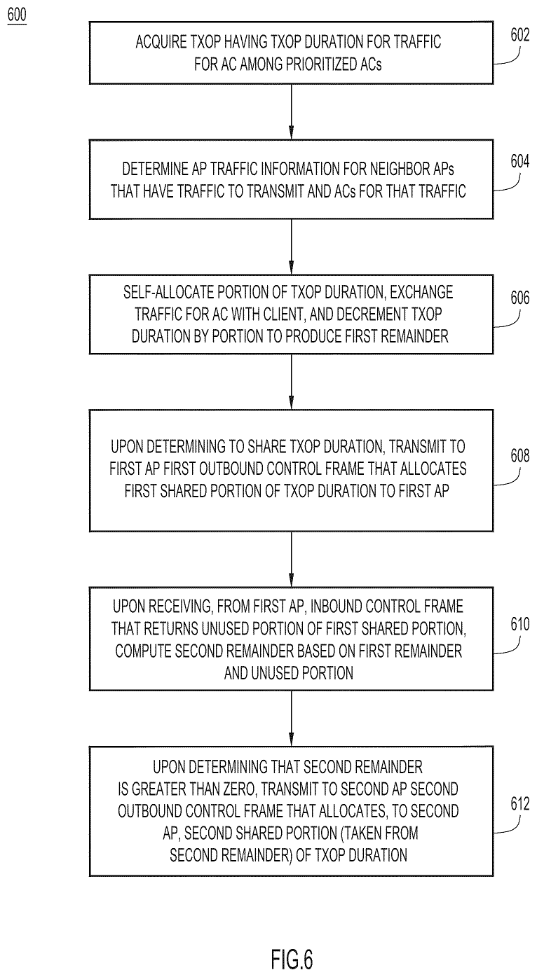

FIG. 6 is a flowchart of an example method 600 of single AP TXOP sharing control performed by an AP using Co-TDMA with MAPC to enforce an AC-based TXOP limit.

At 602, the AP acquires a TXOP having a TXOP duration for traffic for an AC among prioritized ACs. For example, the AP may acquire the TXOP for an AC, where the AC has a TXOP limit, which may be the same TXOP limit as other ACs as well. The prioritized ACs may include ACs for at least voice and video in order from highest to lowest priority. Or the prioritized ACs may include ACs for at least voice, video, and at least best effort in order from highest to lowest priority. The TXOP duration is no greater than a TXOP limit among TXOP limits respectively defined for the prioritized ACs, or might be a lower limit when the AP has little traffic to send. The TXOP limits may be equal to each other for multiple ones of the prioritized ACs.

At 604, the AP determines AP traffic information for (neighbor) APs that indicates which of the APs have the traffic to transmit and ACs (or higher ACs) for each amount of reported traffic. For example, the AP polls the APs for the AP traffic information, or estimates the AP traffic information.

At 606, the AP self-allocates a portion of the TXOP duration, and exchanges traffic for the AC with one or more clients during the portion. The AP decrements the TXOP duration by the portion to produce a first remainder available for sharing with other APs.

Upon determining that the AP traffic information indicates that a first AP has first traffic to transmit for the AC or a higher priority AC, and that the first remainder is greater than zero, at 608, the AP generates and then transmits to the first AP, a first outbound control frame configured to allocate, to the first AP, a first shared portion of the TXOP duration taken from the first remainder and that is to be used by the first AP to exchange first traffic for the AC or a higher priority AC with a first client.

Upon receiving, from the first AP, an inbound control frame configured to return to the AP an unused portion of the first shared portion, at 610, the AP computes a second remainder (i.e., a current/new unused portion) of the TXOP duration that is available for sharing by the AP, based on the first remainder and the unused portion. In an example in which the inbound control frame includes an indication of a used portion of the first shared portion, the AP computes the second remainder by decrementing the first remainder (which is the TXOP duration less the portion used by the AP) by the used portion. In an example in which the inbound control frame includes an indication of the unused portion, the AP computes the second remainder by decrementing the first remainder by a difference between the first shared portion and the unused portion.

Upon determining that the AP traffic information indicates that a second AP has second traffic to transmit for the AC or a higher priority AC, and that the second remainder is greater than zero, at 612, the AP generates, and transmits to the second AP, a second outbound control frame configured to allocate, to the second AP, a second shared portion of the TXOP duration taken from the second remainder to be used by the second AP to exchange the second traffic with a second client.

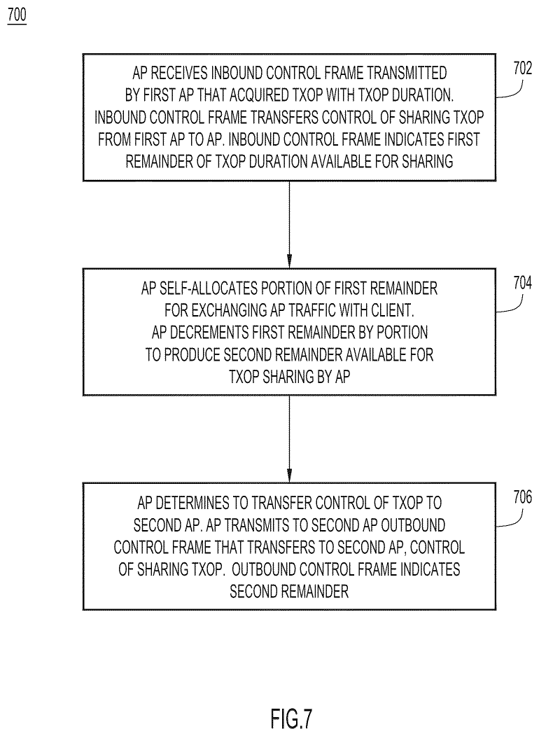

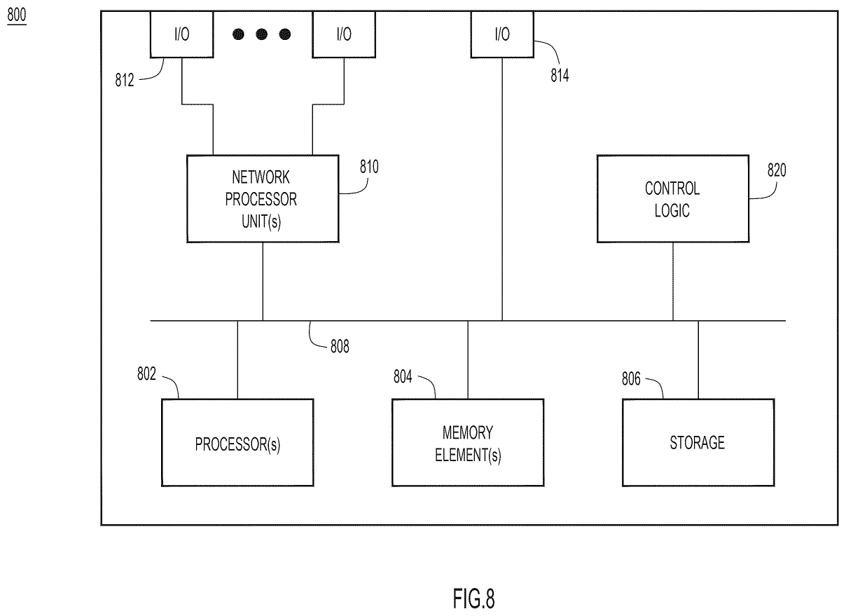

FIG. 7 is a flowchart of an example method 700 of distributed AP TXOP sharing performed by an AP using Co-TDMA with MAPC to enforce an AC-based TXOP limit.

At 702, the AP receives an inbound control frame transmitted by a first AP that acquired a TXOP with a TXOP duration. The inbound control frame is configured to transfer control of sharing the TXOP from the first AP to the AP. The inbound control frame includes (i) an indication of a first remainder (which is greater than zero) of the TXOP duration that is unused and available for sharing, (ii) an indication of an AC (among prioritized ACs) for traffic, and optionally (iii) AP traffic information that indicates APs that have traffic for the AC or a higher priority AC. The TXOP duration may be equal to, but does not exceed, a TXOP limit for Co-TDMA for the AC, which may be calculated as a function of the TXOP limit of multiple ACs when Co-TDM A is not used, such as min (TXOPlimit(AC_xx), TXOPlimit(AC_VI)).

Upon determining that the AP has traffic for the AC or the higher priority AC, at 704, the AP self-allocates a portion of the first remainder for exchanging AP traffic with a client. The AP decrements the first remainder by the portion to produce a second remainder that is unused and available for TXOP sharing by the AP.

At 706, the AP determines to transfer control of the TXOP to a second AP (e.g., the AP determines that the AP traffic history indicates the second AP has traffic for the AC or a higher priority AC, and that the second remainder is greater than zero). The second AP transmits, to the second AP, an outbound control frame configured to transfer the control of the sharing the TXOP (i.e., control of the TXOP) to the second AP. The outbound control frame indicates the second remainder, the AC, and optionally the AP traffic history so that the second AP can continue the distributed AP sharing control. In another example, the AP may return the second remainder to the first AP using a TXOP return frame as described above.

Referring to FIG. 8, FIG. 8 illustrates a hardware block diagram of a computing device 800 that may perform functions associated with operations discussed herein in connection with the techniques depicted in FIGS. 1-7. In various embodiments, a computing device or apparatus, such as computing device 800 or any combination of computing devices 800, may be configured as any entity/entities as discussed for the techniques depicted in connection with FIGS. 1-7 in order to perform operations of the various techniques discussed herein. For example, computing device 800 may represent any of APs 110.

In summary, embodiments presented herein improve fairness with legacy wireless LAN equipment, given TXOP chaining in Co-TDMA, by defining a way for a TXOP limit to be honored within the Co-TDMA. In an example, the embodiments may be implemented in accordance with the IEEE 802.11 standards, extended or modified to implement various aspects of the embodiments. In another example, the embodiments may be implemented in accordance with other communication standards.

In at least one embodiment, the computing device 800 may be any apparatus that may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory element(s) 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 (wired and/or wireless) to facilitate operations discussed for various embodiments described herein. In various embodiments, network processor unit(s) 810 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, any other I/O port(s), and/or antenna(s)/antenna array(s) now known or hereafter developed. Thus, the network processor unit(s) 810 and/or network I/O interface(s) 812 may include suitable interfaces for receiving, transmitting, and/or otherwise communicating data and/or information in a network environment.

I/O interface(s) 814 allow for input and output of data and/or information with other entities that may be connected to computing device 800. For example, I/O interface(s) 814 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 820 can include instructions that, when executed, cause processor(s) 802 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (A SIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®, Wi-Fi7®, Wi-Fi8®, etc.), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method performed by an access point (AP) using coordinated time division multiple access (Co-TDMA) with multi-AP coordination (MAPC), the method including: upon acquiring a transmit opportunity (TXOP) having a TXOP duration for traffic of an access category among prioritized access categories, exchanging the traffic with a client during a portion of the TXOP; and transmitting, to a first AP, a first outbound control frame configured to allocate, to the first AP, a first shared portion of the TXOP duration to be used by the first AP to exchange first traffic for the access category or a higher priority access category with a first client, wherein the first outbound control frame includes a multi-user request-to-send TXOP sharing trigger frame having a first indication of the first shared portion of the TXOP duration, and a second indication of the access category.

In some aspects, the techniques described herein relate to a method, wherein: the prioritized access categories include at least voice, video, and best effort in order from highest to lowest priority; and the TXOP duration is no greater than a maximum TXOP limit among maximum TXOP limits respectively defined for the prioritized access categories for the Co-TDMA with the MAPC.

In some aspects, the techniques described herein relate to a method, wherein: the maximum TXOP limits are equal to each other for multiple ones of the prioritized access categories.

In some aspects, the techniques described herein relate to a method, further including, by the AP: determining AP traffic information for APs that have the traffic to transmit and access categories for the traffic; and upon determining that the AP traffic information indicates that the first AP has the traffic to transmit, performing transmitting the first outbound control frame.

In some aspects, the techniques described herein relate to a method, further including, by the AP: decrementing the TXOP duration by the portion of the TXOP duration used by the AP to produce a first remainder of the TXOP duration that is available for TXOP sharing; and allocating the first shared portion from the first remainder.

In some aspects, the techniques described herein relate to a method, further including, by the AP: upon receiving, from the first AP, an inbound control frame configured to return to the AP an unused portion of the first shared portion, transmitting, to a second AP, a second outbound control frame configured to allocate, to the second AP, a second shared portion of the TXOP duration to be used by the second AP to exchange second traffic with a second client.

In some aspects, the techniques described herein relate to a method, further including, by the AP: computing a remainder of the TXOP duration from which the second shared portion is to be taken based on the TXOP duration, the portion used by the AP, and the unused portion that is returned by the first AP; and allocating the second shared portion from the remainder.

In some aspects, the techniques described herein relate to a method, further including: when the inbound control frame includes an indication of the unused portion, computing the remainder includes decrementing the TXOP duration by the portion used by the AP and a difference between the first shared portion and the unused portion that was not used by the first AP.

In some aspects, the techniques described herein relate to a method, further including: when the inbound control frame includes an indication of a used portion of the second shared portion that was used by the second AP, computing the remainder includes decrementing the TXOP duration by the portion used by the AP and the used portion that was used by the first AP.

In some aspects, the techniques described herein relate to an apparatus including: a network interface unit configured to communicate with network devices of a network; and a processor of an access point (AP) configured to use coordinated time division multiple access (Co-TDMA) with multi-AP coordination (MAPC), wherein the processor is coupled to the network interface unit and configured to perform: upon acquiring an access point (AP) transmit opportunity (TXOP) having a TXOP duration for traffic of an access category among prioritized access categories, exchanging the traffic with a client during a portion of the TXOP; and cause the AP to transmit, to a first AP, a first outbound control frame configured to allocate, to the first AP, a first shared portion of the TXOP duration to be used by the first AP to exchange first traffic for the access category or a higher priority access category with a first client, wherein the first outbound control frame includes a multi-user request-to-send TXOP sharing trigger frame having a first indication of the first shared portion of the TXOP duration, and a second indication of the access category.

In some aspects, the techniques described herein relate to an apparatus, wherein: the prioritized access categories include at least voice, video, and best effort in order from highest to lowest priority; and the TXOP duration is no greater than a maximum TXOP limit among maximum TXOP limits respectively defined for the prioritized access categories for the Co-TDMA with the MAPC.

In some aspects, the techniques described herein relate to an apparatus, wherein: the maximum TXOP limits are equal to each other for multiple ones of the prioritized access categories.

In some aspects, the techniques described herein relate to an apparatus, wherein the processor is further configured to perform: determining AP traffic information for APs that have the traffic to transmit and access categories for the traffic; and upon determining that the AP traffic information indicates that the first AP has the traffic to transmit, cause the AP to transmit the first outbound control frame.

In some aspects, the techniques described herein relate to an apparatus, wherein the processor is further configured to perform: decrementing the TXOP duration by the portion of the TXOP duration used by the AP to produce a first remainder of the TXOP duration that is available for TXOP sharing; and allocating the first shared portion from the first remainder.

In some aspects, the techniques described herein relate to an apparatus, wherein the processor is further configured to perform: upon receiving, from the first AP, an inbound control frame configured to return to the AP an unused portion of the first shared portion, causing the AP to transmit, to a second AP, a second outbound control frame configured to allocate, to the second AP, a second shared portion of the TXOP duration to be used by the second AP to exchange second traffic with a second client.

In some aspects, the techniques described herein relate to an apparatus, wherein the processor is further configured to perform: computing a remainder of the TXOP duration from which the second shared portion is to be taken based on the TXOP duration, the portion used by the AP, and the unused portion that is returned by the first AP; and allocating the second shared portion from the remainder.

In some aspects, the techniques described herein relate to an apparatus, wherein the processor is further configured to perform: when the inbound control frame includes an indication of the unused portion, computing the remainder includes decrementing the TXOP duration by the portion used by the AP and a difference between the first shared portion and the unused portion that was not used by the first AP.

In some aspects, the techniques described herein relate to an apparatus, wherein the processor is further configured to perform: when the inbound control frame includes an indication of a used portion of the second shared portion that was used by the second AP, computing the remainder includes decrementing the TXOP duration by the portion used by the AP and the used portion that was used by the first AP.

In some aspects, the techniques described herein relate to a non-transitory computer readable medium encoded with instructions that, when executed by a processor of an access point (AP) configured to use coordinated time division multiple access (Co-TDMA) with multi-AP coordination (MAPC), cause the processor to perform: upon acquiring a transmit opportunity (TXOP) having a TXOP duration for traffic of an access category among prioritized access categories, exchanging the traffic with a client during a portion of the TXOP; and causing the AP to transmit, to a first AP, a first outbound control frame configured to allocate, to the first AP, a first shared portion of the TXOP duration to be used by the first AP to exchange first traffic for the access category or a higher priority access category with a first client, wherein the first outbound control frame includes a multi-user request-to-send TXOP sharing trigger frame having a first indication of the first shared portion of the TXOP duration, and a second indication of the access category.

In some aspects, the techniques described herein relate to a non-transitory computer readable medium, wherein: the prioritized access categories include at least voice, video, and best effort in order from highest to lowest priority; and the TXOP duration is no greater than a maximum TXOP limit among maximum TXOP limits respectively defined for the prioritized access categories for the Co-TDM A with the MAPC.

In some aspects, the techniques described herein relate to a non-transitory computer readable medium, wherein: the maximum TXOP limits are equal to each other for multiple ones of the prioritized access categories.

In some aspects, the techniques described herein relate to a non-transitory computer readable medium, further including instructions to cause the processor to perform: determining AP traffic information for APs that have the traffic to transmit and access categories for the traffic; and upon determining that the AP traffic information indicates that the first AP has the traffic to transmit, causing the AP to transmit the first outbound control frame.

In some aspects, the techniques described herein relate to a non-transitory computer readable medium, further including instructions to cause the processor to perform: decrementing the TXOP duration by the portion of the TXOP duration used by the AP to produce a first remainder of the TXOP duration that is available for TXOP sharing; and allocating the first shared portion from the first remainder.

In some aspects, the techniques described herein relate to a non-transitory computer readable medium, further including instructions to cause the processor to perform: upon receiving, from the first AP, an inbound control frame configured to return to the AP an unused portion of the first shared portion, causing the AP to transmit, to a second AP, a second outbound control frame configured to allocate, to the second AP, a second shared portion of the TXOP duration to be used by the second AP to exchange second traffic with a second client.

In some aspects, the techniques described herein relate to a non-transitory computer readable medium, further including instructions to cause the processor to perform: computing a remainder of the TXOP duration from which the second shared portion is to be taken based on the TXOP duration, the portion used by the AP, and the unused portion that is returned by the first AP; and allocating the second shared portion from the remainder.

In some aspects, the techniques described herein relate to a non-transitory computer readable medium, further including instructions to cause the processor to perform: when the inbound control frame includes an indication of the unused portion, computing the remainder includes decrementing the TXOP duration by the portion used by the AP and a difference between the first shared portion and the unused portion that was not used by the first AP.

In some aspects, the techniques described herein relate to a non-transitory computer readable medium, further including instructions to cause the processor to perform: when the inbound control frame includes an indication of a used portion of the second shared portion that was used by the second AP, computing the remainder includes decrementing the TXOP duration by the portion used by the AP and the used portion that was used by the first AP.

In some aspects, the techniques described herein relate to a method performed by an access point (AP) using coordinated time division multiple access (Co-TDMA) with multi-AP coordination (MAPC), the method including: receiving an inbound control frame transmitted by a first AP that acquired a transmit opportunity (TXOP) with a TXOP duration, wherein the inbound control frame is configured to transfer control of sharing the TXOP from the first AP to the AP, and the inbound control frame indicates a first remainder of the TXOP duration that is unused and available for sharing; self-allocating a portion of the first remainder for exchanging AP traffic with a client; and decrementing the first remainder by the portion to produce a second remainder that is unused and available for sharing with a second AP.

In some aspects, the techniques described herein relate to a method, wherein: the inbound control frame further indicates an access category among prioritized access categories; and the method further includes, by the AP, upon determining that the AP traffic is for the access category or a higher priority access category, self-allocating the portion of the first remainder for exchanging the AP traffic for the access category.

In some aspects, the techniques described herein relate to a method, wherein: the prioritized access categories include at least voice, video, and at least best effort in order from highest to lowest priority; and the TXOP duration is no greater than equal to a maximum TXOP limit among maximum TXOP limits respectively defined for the prioritized access categories for the Co-TDMA with the MAPC.

In some aspects, the techniques described herein relate to a method, further including: upon determining to transfer the control of the TXOP to the second AP, transmitting, to the second AP, an outbound control frame configured to transfer the control of the sharing the TXOP to the second AP, wherein the outbound control frame indicates the second remainder that is unused and available for sharing with the second AP.

In some aspects, the techniques described herein relate to a method, wherein: determining includes determining that the second remainder is greater than zero.

In some aspects, the techniques described herein relate to a method, wherein: the inbound control frame further includes AP traffic information that indicates APs with traffic to transmit; and determining includes determining that the AP traffic information indicates the second AP with second AP traffic to transmit.

In some aspects, the techniques described herein relate to a method, wherein: transmitting includes transmitting the outbound control frame to further include the AP traffic information.

In some aspects, the techniques described herein relate to a method, wherein: the inbound control frame further includes an indication of an access category among prioritized access categories; and transmitting includes transmitting the outbound control frame to further include the indication of the access category.

In some aspects, the techniques described herein relate to an apparatus including: a network interface unit to communicate with network devices of a network; and a processor of an access point (AP) configured to use coordinated time division multiple access (Co-TDMA) with multi-AP coordination (MAPC), wherein the processor is coupled to the network interface unit and configured to perform: receiving an inbound control frame transmitted by a first AP that acquired a transmit opportunity (TXOP) with a TXOP duration, wherein the inbound control frame is configured to transfer control of sharing the TXOP from the first AP to the AP, and the inbound control frame indicates a first remainder of the TXOP duration that is unused and available for sharing; self-allocating a portion of the first remainder for exchanging AP traffic with a client; and decrementing the first remainder by the portion to produce a second remainder that is unused and available for sharing with a second AP.

In some aspects, the techniques described herein relate to an apparatus, wherein: the inbound control frame further indicates an access category among prioritized access categories; and the processor is further configured to perform, upon determining that the AP traffic is for the access category or a higher priority access category, self-allocating the portion of the first remainder for exchanging the AP traffic for the access category.

In some aspects, the techniques described herein relate to an apparatus, wherein: the prioritized access categories include at least voice, video, and at least best effort in order from highest to lowest priority; and the TXOP duration is no greater than equal to a maximum TXOP limit among maximum TXOP limits respectively defined for the prioritized access categories for the Co-TDMA with the MAPC.

In some aspects, the techniques described herein relate to an apparatus, wherein the processor is further configured to perform: upon determining to transfer the control of the TXOP to the second AP, causing the AP to transmit, to the second AP, an outbound control frame configured to transfer the control of the sharing the TXOP to the second AP, wherein the outbound control frame indicates the second remainder that is unused and available for sharing with the second AP.

In some aspects, the techniques described herein relate to an apparatus, wherein: wherein the processor is configured to perform determining by determining that the second remainder is greater than zero.

In some aspects, the techniques described herein relate to an apparatus, wherein: the inbound control frame further includes AP traffic information that indicates APs with traffic to transmit; and the processor is further configured to perform determining by determining that the AP traffic information indicates the second AP with second AP traffic to transmit.

In some aspects, the techniques described herein relate to an apparatus, wherein: the outbound control frame further includes the AP traffic information.

In some aspects, the techniques described herein relate to an apparatus, wherein: the inbound control frame further includes an indication of an access category among prioritized access categories; and the outbound control frame further includes the indication of the access category.

In some aspects, the techniques described herein relate to a non-transitory computer readable medium encoded with instructions that, when executed by a processor of an access point (AP) configured to use coordinated time division multiple access (Co-TDMA) with multi-AP coordination (MAPC), cause the processor to perform: receiving an inbound control frame transmitted by a first AP that acquired a transmit opportunity (TXOP) with a TXOP duration, wherein the inbound control frame is configured to transfer control of sharing the TXOP from the first AP to the AP, and the inbound control frame indicates a first remainder of the TXOP duration that is unused and available for sharing; self-allocating a portion of the first remainder for exchanging AP traffic with a client; and decrementing the first remainder by the portion to produce a second remainder that is unused and available for sharing with a second AP.

In some aspects, the techniques described herein relate to a non-transitory computer readable medium, wherein: the inbound control frame further indicates an access category among prioritized access categories; and the instructions further include instructions to cause the processor to perform, upon determining that the AP traffic is for the access category or a higher priority access category, self-allocating the portion of the first remainder for exchanging the AP traffic for the access category.

In some aspects, the techniques described herein relate to a non-transitory computer readable medium, wherein: the prioritized access categories include at least voice, video, and at least best effort in order from highest to lowest priority; and the TXOP duration is no greater than equal to a maximum TXOP limit among maximum TXOP limits respectively defined for the prioritized access categories for the Co-TDMA with the MAPC.

In some aspects, the techniques described herein relate to a non-transitory computer readable medium, further including instructions to cause the processor to perform: upon determining to transfer the control of the TXOP to the second AP, causing the AP to transmit, to the second AP, an outbound control frame configured to transfer the control of the sharing the TXOP to the second AP, wherein the outbound control frame indicates the second remainder that is unused and available for sharing with the second AP.

In some aspects, the techniques described herein relate to a non-transitory computer readable medium, wherein: the instructions to cause the processor to perform determining include instructions to cause the processor to perform determining that the second remainder is greater than zero.

In some aspects, the techniques described herein relate to a non-transitory computer readable medium, wherein: the inbound control frame further includes AP traffic information that indicates APs with traffic to transmit; and the instructions to cause the processor to perform determining include instructions to cause the processor to perform determining that the AP traffic information indicates the second AP with second AP traffic to transmit.

In some aspects, the techniques described herein relate to a non-transitory computer readable medium, wherein: the outbound control frame further includes the AP traffic information.

In some aspects, the techniques described herein relate to a non-transitory computer readable medium, wherein: the inbound control frame further includes an indication of an access category among prioritized access categories; and the outbound control frame further includes the indication of the access category.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. M any modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method performed by an access point (AP) using coordinated time division multiple access (Co-TDMA) with multi-AP coordination (MAPC), the method comprising:
upon acquiring a transmit opportunity (TXOP) having a TXOP duration for traffic of an access category among prioritized access categories, exchanging the traffic with a client during a portion of the TXOP; and
transmitting, to a first AP, a first outbound control frame configured to allocate, to the first AP, a first shared portion of the TXOP duration to be used by the first AP to exchange first traffic for the access category or a higher priority access category with a first client, wherein the first outbound control frame includes a multi-user request-to-send TXOP sharing trigger frame having a first indication of the first shared portion of the TXOP duration, and a second indication of the access category.

2. The method of claim 1, wherein:
the prioritized access categories include at least voice, video, and best effort in order from highest to lowest priority; and
the TXOP duration is no greater than a maximum TXOP limit among maximum TXOP limits respectively defined for the prioritized access categories for the Co-TDMA with the MAPC.

3. The method of claim 2, wherein the maximum TXOP limits are equal to each other for multiple ones of the prioritized access categories.

4. The method of claim 1, further comprising, by the AP:
determining AP traffic information for APs that have the traffic to transmit and access categories for the traffic; and
upon determining that the AP traffic information indicates that the first AP has the traffic to transmit, performing transmitting the first outbound control frame.

5. The method of claim 1, further comprising, by the AP:
decrementing the TXOP duration by the portion of the TXOP duration used by the AP to produce a first remainder of the TXOP duration that is available for TXOP sharing; and
allocating the first shared portion from the first remainder.

6. The method of claim 1, further comprising, by the AP:
upon receiving, from the first AP, an inbound control frame configured to return to the AP an unused portion of the first shared portion, transmitting, to a second AP, a second outbound control frame configured to allocate, to the second AP, a second shared portion of the TXOP duration to be used by the second AP to exchange second traffic with a second client.

7. The method of claim 6, further comprising, by the AP:
computing a remainder of the TXOP duration from which the second shared portion is to be taken based on the TXOP duration, the portion used by the AP, and the unused portion that is returned by the first AP; and
allocating the second shared portion from the remainder.

8. An apparatus comprising:
a network interface unit to communicate with network devices of a network; and
a processor of an access point (AP) configured to use coordinated time division multiple access (Co-TDMA) with multi-AP coordination (MAPC), wherein the processor is coupled to the network interface unit and configured to perform:
upon acquiring an access point (AP) transmit opportunity (TXOP) having a TXOP duration for traffic of an access category among prioritized access categories, exchanging the traffic with a client during a portion of the TXOP; and
causing the AP to transmit, to a first AP, a first outbound control frame configured to allocate, to the first AP, a first shared portion of the TXOP duration to be used by the first AP to exchange first traffic for the access category or a higher priority access category with a first client, wherein the first outbound control frame includes a multi-user request-to-send TXOP sharing trigger frame having a first indication of the first shared portion of the TXOP duration, and a second indication of the access category.

9. The apparatus of claim 8, wherein:
the prioritized access categories include at least voice, video, and best effort in order from highest to lowest priority; and
the TXOP duration is no greater than a maximum TXOP limit among maximum TXOP limits respectively defined for the prioritized access categories for the Co-TDMA with the MAPC.

10. The apparatus of claim 9, wherein the maximum TXOP limits are equal to each other for multiple ones of the prioritized access categories.

11. The apparatus of claim 8, wherein the processor is further configured to perform:
determining AP traffic information for APs that have the traffic to transmit and access categories for the traffic; and
upon determining that the AP traffic information indicates that the first AP has the traffic to transmit, cause the AP to transmit the first outbound control frame.

12. The apparatus of claim 8, wherein the processor is further configured to perform:
decrementing the TXOP duration by the portion of the TXOP duration used by the AP to produce a first remainder of the TXOP duration that is available for TXOP sharing; and
allocating the first shared portion from the first remainder.

13. The apparatus of claim 8, wherein the processor is further configured to perform:
upon receiving, from the first AP, an inbound control frame configured to return to the AP an unused portion of the first shared portion, causing the AP to transmit, to a second AP, a second outbound control frame configured to allocate, to the second AP, a second shared portion of the TXOP duration to be used by the second AP to exchange second traffic with a second client.

14. The apparatus of claim 13, wherein the processor is further configured to perform:
computing a remainder of the TXOP duration from which the second shared portion is to be taken based on the TXOP duration, the portion used by the AP, and the unused portion that is returned by the first AP; and
allocating the second shared portion from the remainder.

15. A method performed by an access point (AP) using coordinated time division multiple access (Co-TDMA) with multi-AP coordination (MAPC), the method comprising:
receiving an inbound control frame transmitted by a first AP that acquired a transmit opportunity (TXOP) with a TXOP duration, wherein the inbound control frame is configured to transfer control of sharing the TXOP from the first AP to the AP, and the inbound control frame indicates a first remainder of the TXOP duration that is unused and available for sharing;
self-allocating a portion of the first remainder for exchanging AP traffic with a client; and
decrementing the first remainder by the portion to produce a second remainder that is unused and available for sharing with a second AP.

16. The method of claim 15, wherein:
the inbound control frame further indicates an access category among prioritized access categories; and
the method further comprises, by the AP, upon determining that the AP traffic is for the access category or a higher priority access category, self-allocating the portion of the first remainder for exchanging the AP traffic for the access category.

17. The method of claim 16, wherein:
the prioritized access categories include at least voice, video, and at least best effort in order from highest to lowest priority; and
the TXOP duration is no greater than equal to a maximum TXOP limit among maximum TXOP limits respectively defined for the prioritized access categories for the Co-TDMA with the MAPC.

18. The method of claim 15, further comprising:
upon determining to transfer the control of the TXOP to the second AP, transmitting, to the second AP, an outbound control frame configured to transfer the control of the sharing the TXOP to the second AP, wherein the outbound control frame indicates the second remainder that is unused and available for sharing with the second AP.

19. The method of claim 18, wherein:
determining includes determining that the second remainder is greater than zero.

20. The method of claim 18, wherein:
the inbound control frame further includes AP traffic information that indicates APs with traffic to transmit; and
determining includes determining that the AP traffic information indicates the second AP with second AP traffic to transmit.
